(19) United States
(12) Patent Application Publication
(10) Pub. No.: US 2002/0108443 A1
(43) Pub. Date: Aug. 15, 2002

(54) Method of analyzing the condition of a surface

(76) Inventor: Ian David Kimber, Bracknell (GB)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 10/071,893

(22) Filed: Feb. 9, 2002

(30) Foreign Application Priority Data
Feb. 9, 2001 (GB) 0103220.0

(51) Int. Cl. G01N 29/00

(52) U.S. Cl. 73/587

(57) ABSTRACT

A method of analyzing the condition of a surface such as that of a rail, includes: causing a vehicle to travel along the rail, the vehicle having a first wheel and a second wheel which are in contact with the rail; detecting through the first wheel sound signals propagating along the rail from the second wheel as a consequence of the second wheel traveling along the rail; and analyzing the characteristic features of these sound signals to determine the condition of the rail. This method avoids the use of an ultrasonic sound generator, and can be fitted to standard freight and/or passenger trains to provide a constantly updated picture of the condition of the rails in a railway system.

### BACKGROUND OF THE INVENTION

1. Field of the Invention

The present invention relates to a method of analyzing the condition of a surface, the method relates particularly, though not exclusively, to a method of analyzing the condition of the surface of a rail in a railway system.

2. Prior Art

Current methods for inspecting rails in railway systems use dedicated, slow moving rolling stock, having equipment which generates ultrasonic signals which are coupled into the rails to provide a diagnostic capability. This method is slow and disruptive to train timetables, and requires additional rolling stock and manpower. It is an object of the present invention to mitigate the disadvantages of known methods of rail inspection.

### SUMMARY OF THE INVENTION

According to the present invention, there is provided a method of analyzing the condition of a surface as specified in the claims. This method can avoid the use of an ultrasonic sound generator, and can be fitted to standard freight and/or passenger trains to provide a constantly updated picture of the condition of the rails in a railway system.

According to the present invention a method is provided for analyzing the condition of a surface region. The method consists of or includes the following steps,

a) causing or permitting a wheel to travel along a surface,

b) detecting through said wheel sound signals, the sound signals being a consequence of the wheel contact with the surface, and

c) analyzing the characteristic features of the said sound signals to determine the physical condition of the surface region adjacent said wheel.

In another aspect of the invention, a method is provided for analyzing the condition of a surface region. This method consists of or includes the following steps,

a) causing or permitting a first wheel and a second wheel which are both in contact with a surface to travel along said surface,

b) detecting through said first wheel sound signals propagating along the surface region from said second wheel, the sound signals being a consequence of the second wheel traveling along the surface, and

c) analyzing the characteristic features of the said sound signals to determine the physical condition of the surface region between the two wheels.

In a still further refinement of the invention, a method is provided for analyzing the condition of a surface region, the method consisting of or including the following steps,

a) causing or permitting a first wheel and a second wheel which are in contact with a surface to travel along said surface,

b) detecting through said first wheel sound signals propagating along the surface region from said second wheel, the sound signals being a consequence of the second wheel traveling along the surface,

c) detecting through said second wheel sound signals propagating along the surface region from said first wheel, the sound signals being a consequence of the first wheel traveling along the surface, and

d) analyzing the characteristic features of the said sound signals to determine the physical condition of the surface region between the two wheels, the analysis including cross-correlation.

In the method of the invention, the surface is the surface of a rail. Also, the first wheel and the second wheel share a common plane of rotation. Further, in the method as stated above, step c) may comprise using a correlation or matched filter signal processing system to separate the components of the contact area signal traveling clockwise and anti-clockwise round the wheel from the total detected signal.

Also contemplated by the present invention is apparatus comprising: a wheel for engaging a surface, said wheel having a sound signal detector mounted thereon; a transmitter for transmitting detected sound signals to an analyzer, which includes a signal processing, for analyzing the characteristic features of the said detected sound signals to determine the physical condition of the surface region adjacent said wheel.

The method of the invention analyzes the condition of a surface such as that of a rail, and includes: causing a vehicle to travel along the rail, the vehicle having a first wheel and a second wheel which are in contact with the rail; detecting through the first wheel sound signals propagating along the rail from the second wheel as a consequence of the second wheel traveling along the rail; and analyzing the characteristic features of these sound signals to determine the condition of the rail. This method avoids the use of an ultrasonic sound generator, and can be fitted to standard freight and/or passenger trains to provide a constantly updated picture of the condition of the rails in a railway system.

### BRIEF DESCRIPTION OF THE DRAWINGS

The invention will now be described, by way of example only, with reference to the accompanying schematic drawings.

FIG. 1 shows an arrangement comprising two wheels according to the invention.

FIG. 2 shows one of the wheels from FIG. 1 in more detail.

### DETAILED DESCRIPTION OF PREFERRED EMBODIMENTS OF THE INVENTION

The detection of cracks and micro-cracks in material through their disturbance of the propagation of ultrasonic bulk and surface waves is well known. The disturbance can take the form of both transmission changes and reflections. Performing such detection in railway lines using for example a train traveling at many kilometers per hour is difficult. In the present invention it is the sound which the individual wheels of a normal train make whilst rolling on the track which is used to provide the sound signal rather than that from a separate source of ultrasonic energy.

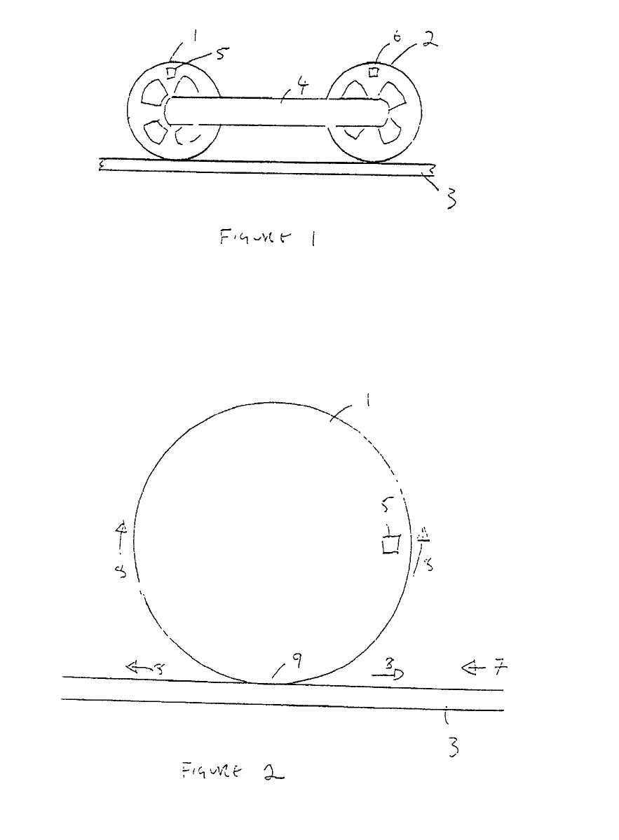

Train wheels are often coupled together in pairs, mounted on frames called bogies. Such an arrangement is shown in FIG. 1 where a pair of wheels (1, 2) are running on a track (3). The wheels are coupled together by a frame (4) having bearings which support the axles (not shown). A broad band ultrasonic sound detection transducer (5, 6) is coupled to each wheel. These transducers are able to pick up the sounds made by the rolling contact of the wheels on the rail. In general, both transducers will pick up sounds from both wheels. The two sound signals arriving at each transducer can be separated by performing an analysis such as cross-correlation in the phase domain, such that the sounds produced from the two wheels propagating in different directions along the track may be separately identified and analyzed further if desired. The condition of the rails is related to the quality and bandwidth of propagation of the sound signals.

The presence of micro-cracks or other damage in the rail will degrade the propagation of sound in the rails. Thus an analysis of the properties of the received sounds will give an indication of the condition of the surface regions of the rail. The information is not regarded as a primary measurement of the size and density of cracks in the rail, but as an ongoing economical daily check which can indicate parts of the railway system where rapid changes in rail condition are occurring, without undertaking a full survey of the whole railway system. If the ownership of rolling stock and track is in different hands, the information gathered by the owner of the rolling stock can be sold to the track owner to provide an additional source of revenue.

FIG. 2 shows a railway wheel (1) in rolling contact with the track (3) and rolling from left to right. Consider it to be the rear wheel of a bogie with another wheel ahead of it (not shown) generating incoming rail borne sound (7) while it generates its own sound (8) radiating from the contact area (9) along the rails in either direction and round the wheel in both directions.

It is to be expected that most of the sound from a rolling point of contact consists of surface/ shear waves caused by the material distortion at the point of contact. These will radiate from this point at a velocity of about 3000 m/s for surface waves and 3200 m/s for bulk/shear waves.

Consider the effect of these waves on detector transducer (5) mounted on the wheel reasonably close to the rim of the wheel. Firstly, there are two major signal paths round the wheel, clockwise and anti-clockwise. As the wheel rotates, the signal from the contact are will be delay and Doppler frequency modulated. The delay is speed invariant but the Doppler is speed dependent. Far from being a problem, this modulation serves to isolate the contact area signal from all other signals in the system (for example bearing noise at the wheel hub). This modulation has strong similarities with a spread spectrum carrier and a correlation or matched filter signal processing scheme can be used to filter the clockwise and anti-clockwise components of the contact area signal from the total signal.

If required it would also be possible to create a composite “contact area” signal. The “contact area” signal will also include incoming signal from the other wheel. This will not be strongly attenuated if the rail is in good condition. If the leading wheel in the bogie has a similar signal detector and processor the cross-correlation of the two composite contact area signals will show peaks related to the propagation of the sound from one wheel to the other. It is also possible to identify the bulk and surface wave components because of their different velocities.

If the or each wheel has just one detector transducer, when the transducer is at the top of its travel (i.e. at its furthest distance from the rail) the detected signal can suffer high levels of attenuation and/or aberration. It is therefore preferred to have a plurality of detector transducers spaced round the circumference of the or each wheel, such that the detector transducer closest to the track (or the one picking up the strongest/least distorted signal) can be chosen to supply the signal to the signal processing means. If two detectors are placed on opposite sides of the wheel, the signal then only has to travel up to one quarter of the circumference of the wheel in one direction and three quarters in the reverse direction. The signal processing to null the clutter should be less difficult in this case at the expense of having to merge two signal sources phase coherently. There are several ways in which sound analysis with a system like this could be used to evaluate track quality. The presence of microscopic cracks causes the propagation of sound from one wheel to the other to be affected—either attenuated or having its frequency content changed. Cracks can also generate unusual non-linear noises when run over and these detected at both wheels to confirm their presence. It is possible that sounds caused by strain in the track under load could be used either alternatively or in addition.

Early detection of deterioration and progressive measurement with “in service” trains passenger and/or freight trains could offer a just in time repair option for the system.

The system can also be used as a research tool to help understand the dynamic interaction between the wheels and the track. This could allow designs to be improved.

The system may not be fully effective over joins in track or in areas where there are many junctions, however these are usually in well-monitored areas. It may also be dependent on train speed, but with fast processing it should be possible to process the signals in real time at high speed.

Although the invention has been described in terms of preferred embodiments, changes will be evident to those of skill in the art which do not depart from the teachings herein. Such changes are deemed to fall within the purview of the invention as stated in the claims.

What is claimed is:

1. A method of analyzing the condition of a surface region, the method consisting of or including the following steps:
a) causing or permitting a wheel to travel along a surface,
b) detecting through said wheel sound signals, the sound signals being a consequence of the wheel contact with the surface, and
c) analyzing the characteristic features of the said sound signals to determine the physical condition of the surface region adjacent said wheel.

2. A method of analyzing the condition of a surface region, the method consisting of or including the following steps:
a) causing or permitting a first wheel and a second wheel which are both in contact with a surface to travel along said surface,
b) detecting through said first wheel sound signals propagating along the surface region from said second wheel, the sound signals being a consequence of the second wheel traveling along the surface, and
c) analyzing the characteristic features of the said sound signals to determine the physical condition of the surface region between the two wheels.

3. A method of analyzing the condition of a surface region, the method consisting of or including the following steps:
a) causing or permitting a first wheel and a second wheel which are in contact with a surface to travel along said surface,
b) detecting through said first wheel sound signals propagating along the surface region from said second wheel, the sound signals being a consequence of the second wheel traveling along the surface,
c) detecting through said second wheel sound signals propagating along the surface region from said first wheel, the sound signals being a consequence of the first wheel traveling along the surface, and
d) analyzing the characteristic features of the said sound signals to determine the physical condition of the surface region between the two wheels, the analysis including cross-correlation.

4. A method according to claim 1 in which the surface is the surface of a rail.

5. A method as claimed in claim 2 in which the first wheel and the second wheel share a common plane of rotation.

6. A method according to claim 1 in which step c) comprises using a correlation or matched filter signal processing system to separate the components of the contact area signal traveling clockwise and anti-clockwise round the wheel from the total detected signal.

7. Apparatus comprising: a wheel for engaging a surface, said wheel having a sound signal detector mounted thereon; a transmitter for transmitting detected sound signals to an analyzer, which includes a signal processing, for analyzing the characteristic features of the said detected sound signals to determine the physical condition of the surface region adjacent said wheel.
